(19) United States
(12) Patent Application Publication
(10) Pub. No.: US 2024/0262505 A1
(43) Pub. Date: Aug. 8, 2024

(54) MOVING OBJECT

(71) Applicant: HONDA MOTOR CO., LTD., Tokyo (JP)

(72) Inventors: Victor Alcahud Guim, Wako-shi (JP); Michihito Okado, Wako-shi (JP); Takao Kanki, Wako-shi (JP)

(21) Appl. No.: 18/432,120

(22) Filed: Feb. 5, 2024

(30) Foreign Application Priority Data
Feb. 7, 2023 (JP) 2023-016490

(51) Int. Cl. B64D 11/00

(52) U.S. Cl. CPC B64D 11/003

(57) ABSTRACT

A moving object includes a seat installed on a floor of a passenger cabin, and a storage portion provided below the seat and capable of storing baggage of a passenger seated on the seat. At least a part of the storage portion is located below a floor surface of the passenger cabin.

### CROSS-REFERENCE TO RELATED APPLICATIONS

This application is based upon and claims the benefit of priority from Japanese Patent Application No. 2023-016490 filed on Feb. 7, 2023, the contents of which are incorporated herein by reference.

### BACKGROUND OF THE INVENTION

### Field of the Invention

The present disclosure relates to a moving object.

### Description of the Related Art

JP 2010-514618 A discloses a baggage storage (accommodation) device for a vehicle (moving object).

### SUMMARY OF THE INVENTION

There is a demand for a moving object capable of more suitably storing baggage.

An object of the present invention is to solve the above-mentioned problem.

According to a first aspect of the present invention, there is provided a moving object including: a seat installed on a floor of a passenger cabin; and a storage portion provided below the seat and configured to store baggage of a passenger seated on the seat, wherein at least a part of the storage portion is located below a floor surface of the passenger cabin.

According to the present invention, a moving object capable of more suitably storing baggage is provided.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of a moving object according to an embodiment;

FIG. 2 is a top view looking down on a passenger cabin and a cockpit;

FIG. 3 is a side view of seats and the floor of the passenger cabin;

FIG. 4 is a perspective view of the seat and the floor of the passenger cabin;

FIG. 5 is a schematic view showing a storage portion;

FIG. 6 is a schematic view showing a displacement restriction portion according to a first modification;

FIG. 7 is a schematic view showing a storage portion according to a second modification; and

FIG. 8 is a schematic view showing a storage portion according to a third modification.

### DETAILED DESCRIPTION OF THE INVENTION

Seats provided in a moving object may be each provided with a shock absorber. The shock absorber absorbs a load applied to a seat portion of the seat by causing the seat portion to make reciprocating motion in a vertical direction.

The baggage storage device disclosed in JP 2010-514618 A is installed between a seat portion and a floor. Such a baggage storage device hinders the seat portion from moving downward. As such, the baggage storage device according to JP 2010-514618 A cannot be installed below the seat that makes reciprocating motion in the vertical direction. There is a demand for a baggage storage (accommodation) structure that can be installed even under the seat that makes the reciprocating motion in the vertical direction.

In view of the above situation, an embodiment is described below.

### Embodiment

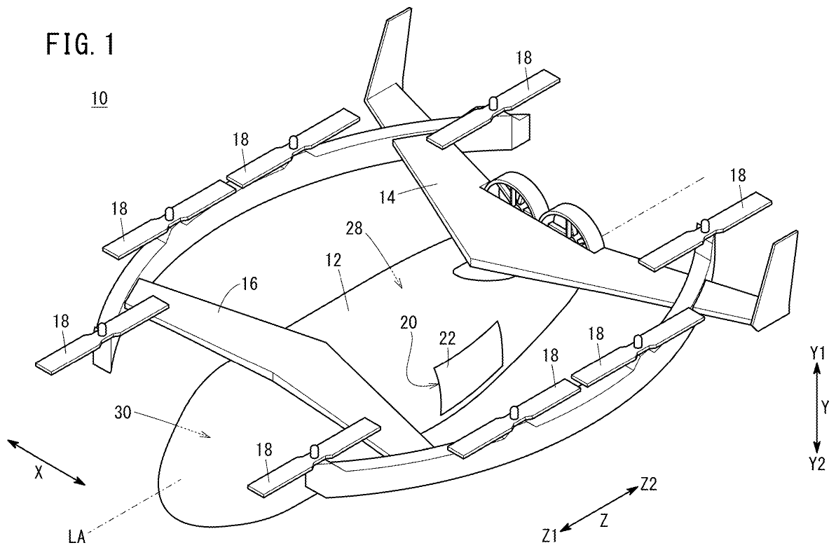

FIG. 1 is a perspective view of a moving object 10 according to the present embodiment. Note that FIG. 1 shows a front-rear direction Z (Z1, Z2), a vertical direction Y (Y1, Y2), and a widthwise direction X. The front-rear direction Z, the vertical direction Y, and the widthwise direction X are orthogonal to each other. The downward direction Y2 indicates the gravity direction.

The moving object 10 is a vehicle that carries passengers. In the present embodiment, a case where the moving object 10 is an electronic vertical take-off and landing aircraft (eVTOL) will be described, but the present invention is not limited to this. For example, the moving object 10 may be a vertical take-off and landing aircraft (VTOL) such as a helicopter, or an automobile or the like. Note that the eVTOL (VTOL) belongs to an aircraft.

The moving object 10 includes a fuselage (body) 12. The fuselage 12 has a cylindrical shape extending along the center line LA, but is not limited thereto. The moving object 10, which is an eVTOL, may further include a main wing 14, which is a fixed wing, a front wing 16 disposed forward of the main wing 14, and a plurality of electric rotary wings 18. More detailed description thereof will be omitted.

A doorway (entrance/exit) 20 is formed in the fuselage 12. The doorway 20 is an opening formed such that passengers and crews can get on and off the moving object 10. The number of the doorways 20 formed in the fuselage 12 is one, for example, but is not limited thereto.

The doorway 20 is provided with a doorway door 22 so as to be openable and closable. The doorway door 22 shown in FIG. 1 is in a closed state. The doorway door 22 is opened and closed by sliding in the front-rear direction Z, for example, but is not limited thereto. The doorway door 22 may be a single swing door or a double swing door.

The fuselage 12 further includes a passenger cabin 28 and a cockpit 30. The passenger cabin 28 and the cockpit 30 are formed inside the fuselage 12.

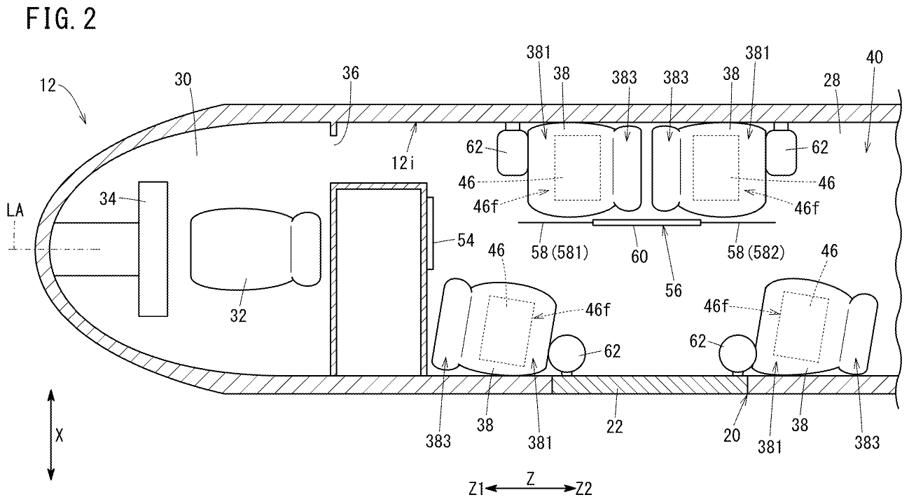

FIG. 2 is a top view looking down on the passenger cabin 28 and the cockpit 30.

The cockpit 30 is located in front of the passenger cabin 28, but is not limited thereto. The cockpit 30 includes, for example, a pilot's seat 32 and an operation panel 34. A crew who operates the moving object 10 sits on the pilot's seat 32. The operation panel 34 is operated to control the moving object 10.

The cockpit 30 and the passenger cabin 28 communicate with each other via a communication passage 36. The crew can move between the cockpit 30 and the passenger cabin 28 through the communication passage 36. A door may be provided for the communication passage 36.

The passenger cabin 28 is used by passengers. The above-described doorway 20 communicates with the passenger cabin 28. One or more seats 38 are installed on a floor 40 of the passenger cabin 28. A plurality of seats 38 are installed in the passenger cabin 28 shown in FIG. 2. More specifically, four seats 38 are installed in the passenger cabin 28 shown in FIG. 2. The plurality of seats 38 are adjacent to an inner wall 12i of the fuselage 12, but the present invention is not limited thereto. A power machine room (not shown) can be provided behind the passenger cabin 28. The power machine room can include equipment for driving the moving object 10. The equipment may include, for example, an engine, a motor for power generation, a battery, and the like.

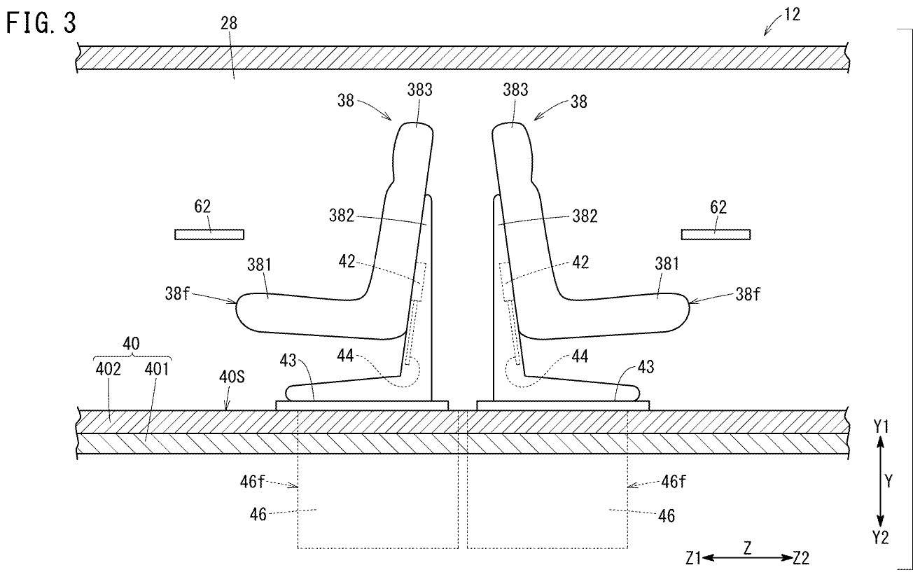

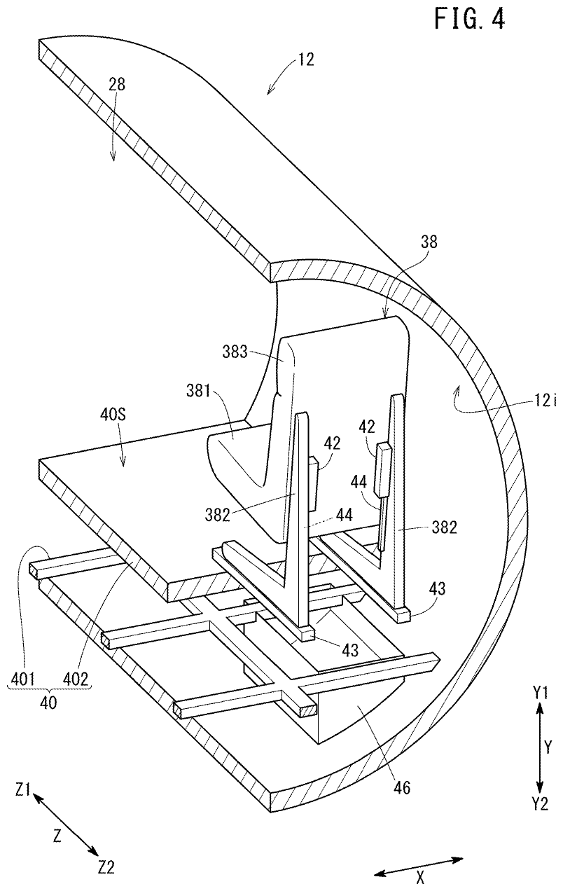

FIG. 3 is a side view showing the seats 38 and the floor 40 of the passenger cabin 28. FIG. 4 is a perspective view showing the seat 38 and the floor 40 of the passenger cabin 28. Incidentally, although only some of the plurality of seats 38 shown in FIG. 2 are shown in FIGS. 3 and 4, the following description of the seats 38 can be applied similarly to all of the seats 38 provided in the passenger cabin 28.

The floor 40 of the passenger cabin 28 includes a beam member 401 and a floor member 402. The beam member 401 is a lattice-shaped member extending in the horizontal direction (the front-rear direction Z, the widthwise direction X). The beam member 401 may be a part of a frame structure forming a skeletal frame of the fuselage 12. The floor member 402 is a flat member that forms a floor surface 40S. The floor member 402 is supported by the beam member 401. The upper surface of the floor member 402 forms the floor surface 40S.

Each of the plurality of seats 38 includes a seat portion 381, a pair of leg portions 382, and a backrest 383. The seat portion 381 is a portion on which a passenger sits. The pair of leg portions 382 supports the seat portion 381. The pair of leg portions 382 are installed on the floor 40. More specifically, the pair of leg portions 382 are installed on the floor 40 via a pair of seat rails 43 fixed to the floor 40 (see also FIGS. 3 and 4). Each of the seats 38 is supported by the pair of seat rails 43 so as to be displaceable in the front-rear direction Z. The pair of leg portions 382 may be fixed to the floor 40. In this case, the pair of seat rails 43 may be omitted. The pair of leg portions 382 are adjacent to each other in the widthwise direction of the seat 38. The backrest 383 supports a passenger seated on the seat portion 381, from behind.

Each of the plurality of seats 38 further includes a shock absorber (a pair of shock absorbers) 42. The shock absorber 42 is a device that absorbs a load applied to the seat portion 381 by enabling the seat portion 381 to make reciprocating motion along the vertical direction Y. The shock absorber 42 includes, for example, an air cylinder, an elastic member, and the like (not shown). The shock absorber 42 can reduce a load applied to the passenger in the vertical direction Y when the moving object 10, which is, for example, an eVTOL, moves along the vertical direction Y.

The range of the reciprocating motion in the vertical direction of the seat portion 381 by the shock absorber 42 can be limited by the rails (a pair of rails) 44 provided on each of the pair of leg portions 382. In this case, the shock absorbers 42 cause the seat portion 381 to make the vertical reciprocating motion along the rails 44. In other words, the seat portion 381 can be displaced in the vertical direction Y along the rails 44 by the shock absorbers 42. Incidentally, the range of the vertical reciprocating motion of the seat portion 381 preferably does not include a lower side with respect to the floor surface 40S.

The moving object 10 further includes a storage portion (accommodation portion) 46 in which a passenger can put baggage. The storage portion 46 is provided below the seat 38. Specifically, the storage portion 46 is positioned below the seat portion 381. More specifically, the storage portion 46 is located between the pair of leg portions 382 in a plan view. Since the storage portion 46 is positioned below the seat 38, the passenger can put baggage in the storage portion 46 while being near the seat 38.

It is preferable that a front end 46f of the storage portion 46 is located rearward of a front end 38f of the seat portion 381 in a plan view. In other words, it is preferable that the front end 46f of the storage portion 46 and the seat portion 381 overlap each other in a top view (see also FIG. 2). This makes it possible for the floor surface 40S to be arranged in front of the front end 38f of the seat portion 381 in a plan view. The passenger can rest his/her feet on the floor surface 40S located forward of the front end 38f of the seat portion 381. In this case, the front and the rear are defined based on the orientation of the seat 38. The orientation of the seat 38 can be identified by the orientation of the backrest 383 provided on the seat 38.

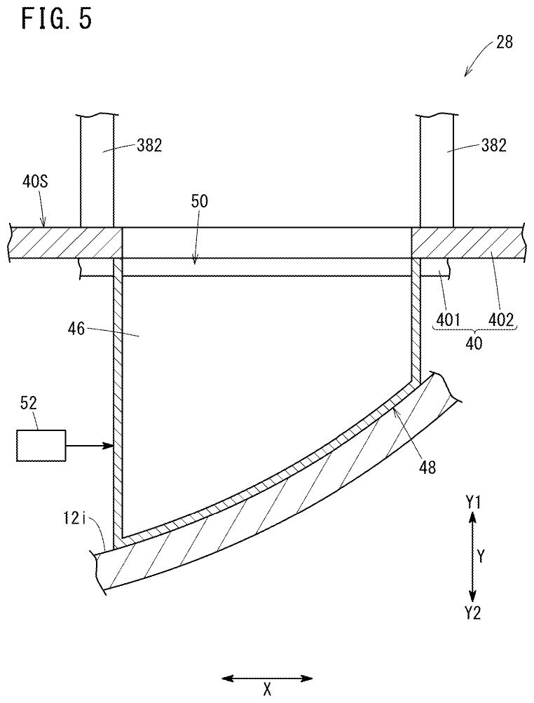

FIG. 5 is a schematic view showing the storage portion 46.

At least a part of the storage portion 46 is positioned below the floor surface 40S of the passenger cabin 28. It is preferable that the entire storage portion 46 be positioned below the floor surface 40S of the passenger cabin 28. This prevents the storage portion 46 from hindering the reciprocating motion of the seat 38 along the vertical direction Y. The storage portion 46 is configured by, for example, a recessed portion 48 formed below the floor surface 40S.

The moving object 10 further includes a displacement restriction portion (displacement restriction member) 50. The displacement restriction portion 50 restricts the displacement of baggage in the vertical direction Y inside the storage portion 46. In other words, the displacement restriction portion 50 prevents luggage from coming out of the storage portion 46.

The displacement restriction portion 50 is formed of, for example, at least a part of the beam member 401 described above. That is, at least a portion of the beam member 401 may lie inside the storage portion 46. The beam member 401 located inside the storage portion 46 can function as a stopper that prevents baggage stored below the beam member 401 from coming out of the storage portion 46. Moreover, the beam member 401 supporting the floor member 402 is used also as the displacement restriction portion 50, and thus it is possible to suppress the number of components provided in the moving object 10.

The moving object 10 further includes a baggage detection sensor 52 and a notification unit (notification device) 54 (see FIG. 2).

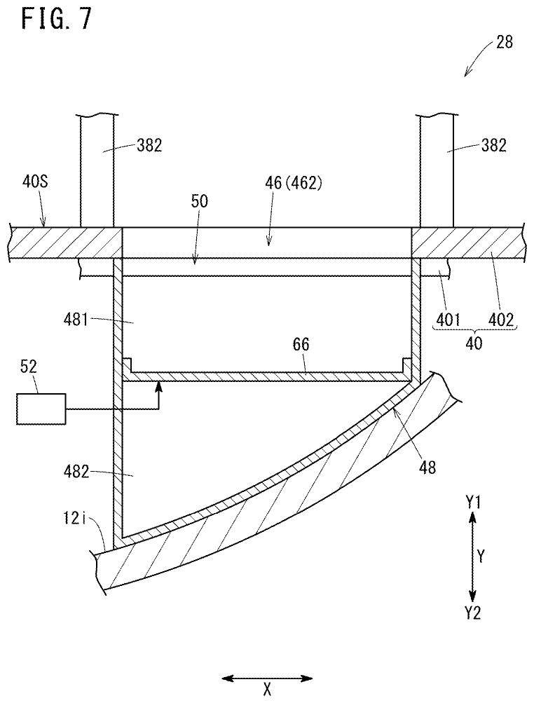

The baggage detection sensor 52 is a sensor for detecting whether or not baggage is stored in the storage portion 46. The baggage detection sensor 52 is, for example, a weight sensor that detects a load received by a partition member 66 (see FIG. 7), which will be described later, but is not limited thereto. The baggage detection sensor 52 may be a distance sensor provided in the storage portion 46.

The notification unit 54 includes, for example, a display installed in the passenger cabin 28, but is not limited thereto. When the moving object 10 arrives at the destination, if baggage is stored in the storage portion 46, then the notification unit 54 gives notification indicating that the baggage is stored in the storage portion 46. For example, when the moving object 10, which is an aircraft, lands on the destination, if baggage is stored in the storage portion 46, then the notification unit 54 gives notification indicating that the baggage is stored in the storage portion 46.

This can prevent the passenger from leaving the baggage in the storage portion 46 when getting off the moving object 10. By giving the notification indicating that the baggage is stored in the storage portion 46 after the landing of the moving object 10, it is possible to prevent the passenger from starting to take out the baggage before the landing of the moving object 10.

The moving object 10 further includes a shielding device 56 (see also FIG. 2). The shielding device 56 includes a pair of partitions 58 (581, 582) and a main body 60. The pair of partitions 58 are accommodated in the main body 60 so as to be able to be projected (deployed).

The main body 60 is provided with an actuator (not shown). The actuator (not shown) includes, for example, a motor, but is not limited thereto. The actuator (not shown) can project the partition 58.

The first partition 581, which is one of the pair of partitions 58, is projected toward the front side of the main body 60. Thus, the space between the two seats 38 located on the front side of the main body 60 is shielded by the first partition 581.

The second partition 582, which is the other of the pair of partitions 58, is projected toward the rear side of the main body 60. Thus, the space between the two seats 38 located on the rear side of the main body 60 is shielded by the second partition 582. At least one of the pair of partitions 58 may be omitted.

The moving object 10 further includes one or more tables 62 (see also FIG. 2). The tables 62 are installed in the passenger cabin 28. The tables 62 are provided for use by passengers. For example, the same number of the tables 62 as the seats 38 are installed in the passenger cabin 28, but the present invention is not limited thereto.

The shape of the table 62 is not particularly limited. The table 62 is, for example, a foldable table that can be accommodated in a wall portion, but is not limited thereto. The table 62 may be mounted to a wall portion of the passenger cabin 28, if desired. The table 62 may be attached to the doorway door 22.

### Modifications

Modifications of the above-described embodiment will be described below. Note that elements already described in the above embodiment are denoted by the same reference numerals as those in the above embodiment unless otherwise specified. Further, the description overlapping with the above embodiment will be omitted as appropriate.

### Modification 1

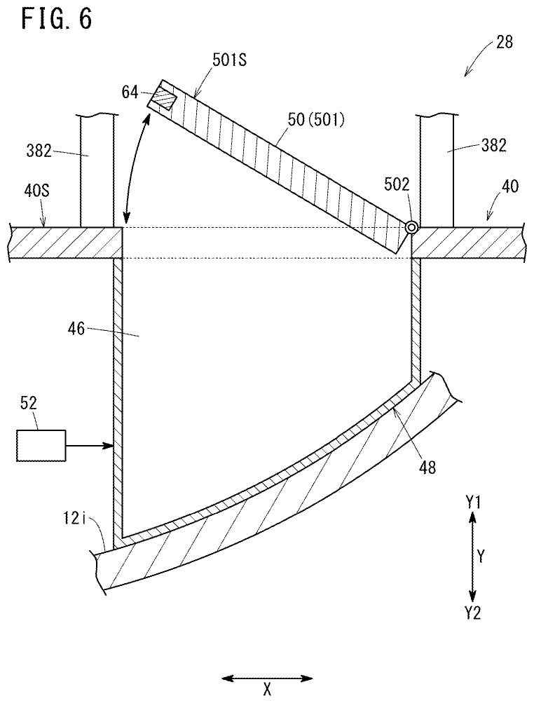

FIG. 6 is a schematic view showing a displacement restriction portion 50 (501) according to a first modification.

The displacement restriction portion 501 is a lid member that closes the storage portion 46. In the following description, the displacement restriction portion 501 is also referred to as the lid member 501.

The lid member 501 closes up the storage portion 46 to prevent baggage from coming out of the storage portion 46. The lid member 501 is attached to the floor 40 by a coupling member 502 such as a hinge so as to be openable and closable, but is not limited thereto. The lid member 501 may be installed on the floor 40 so as to be slidable in a direction parallel to the floor surface 40S. In a state where the storage portion 46 is closed by the lid member 501, the upper surface 501S of the lid member 501 and the floor surface 40S are preferably flush with each other, but are not limited thereto.

The moving object 10 preferably further includes a locking mechanism 64. The locking mechanism 64 is a mechanism for maintaining the lid member 501 in a closed state. The locking mechanism 64 is, for example, a computer-controllable electromagnetic lock. In this case, the electromagnetic lock is controlled by a computer (not shown).

The computer (not shown) controls the electromagnetic lock to lock the lid member 501 when the moving object 10, which is an eVTOL, is ready for taking-off and landing. Accordingly, when the moving object 10 is ready for taking-off and landing, baggage is more reliably prevented from coming out of the storage portion 46.

The locking mechanism 64 is not limited to the electromagnetic lock. For example, the locking mechanism 64 may include a claw portion and an engagement portion with which the claw portion engages. One of the claw portion and the engagement portion may be provided on the lid member 501. The other of the engagement portion and the claw portion may be provided on the floor 40.

It is preferable that a lock sensor (not shown) that detects the locked state of the lid member 501 by the locking mechanism 64 is provided in the moving object 10. When the lock sensor detects that the lid member 501 is not locked, the passenger can be notified that the lid member 501 is not locked by using the notification unit 54. The moving object 10 may further include an illumination unit (not shown) that illuminates the storage portion 46 in accordance with the open/closed state (lock state) of the lid member 501. The illumination unit may include, for example, a light bulb, a fluorescent lamp, a light-emitting diode (LED), or the like. The illumination unit is turned on when the lid member 501 is in the open state (unlocked state), for example. This makes it easy for passengers to check the inside of the storage portion 46 even in the night-time, for example. The illumination unit is turned off when the lid member 501 is in the closed state (locked state). This makes it possible to curb the energy consumption of the illumination unit.

### Modification 2

FIG. 7 is a schematic view showing a storage portion 46 (462) according to a second modification.

At least a part of the recessed portion 48 formed below the floor 40 may be used to store components of the moving object 10. The components of the moving object 10 include, for example, a harness, but is not limited thereto.

When at least a part of the recessed portion 48 is used to store components of the moving object 10, it is not preferable that the components and the baggage of the passenger are mixed. In view of this, a partition member 66 may be provided inside the recessed portion 48 as shown in FIG. 7. The partition member 66 is a member extending in parallel to the floor surface 40S. The partition member 66 can partition the inside of the recessed portion 48 into a first space 481 and a second space 482.

The first space 481 is a space from the opening end of the recessed portion 48 to the partition member 66. The first space 481 may be used as a storage portion 462 for storing baggage of passengers. In this case, the partition member 66 forms the bottom of the storage portion 462.

The baggage detection sensor 52, which is a weight sensor, may detect a load received by the partition member 66, which is the bottom of the storage portion 462. Thus, in the present modification, the baggage detection sensor 52 can also detect whether or not baggage is stored in the storage portion 462.

The second space 482 is a space located below the first space 481. The second space 482 is a space from the partition member 66 to the lower end of the recessed portion 48.

The second space 482 is covered by the partition member 66 and is thus out of view of the passenger. The second space 482 can be used as a space for storing components of the moving object 10.

### Modification 3

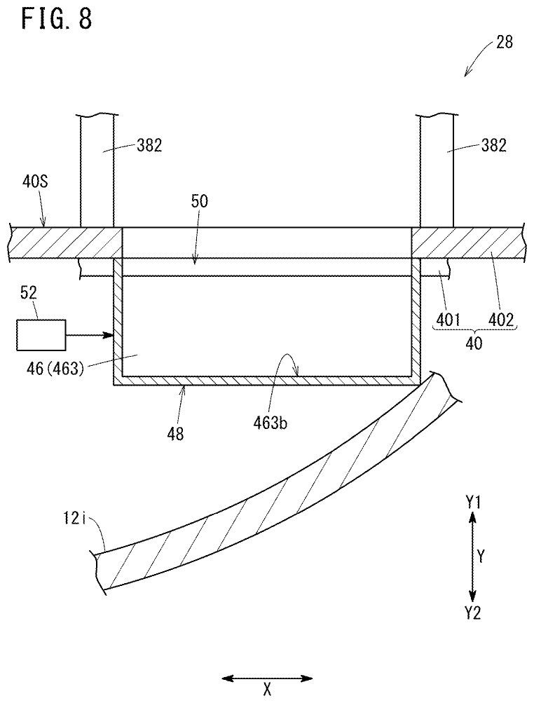

FIG. 8 is a schematic view showing a storage portion 46 (463) according to a third modification.

The storage portion 463 has a bottom 463b parallel to the floor surface 40S. In this way, the shape of the storage portion 46 may be changed as appropriate.

### Combination of Plurality of Modifications

The plurality of modifications described above may be appropriately combined within a range in which technical inconsistencies do not occur therein.

### Appendixes

With respect to the above disclosure, the following Appendixes are further disclosed.

### Appendix 1

The moving object (10) according to the present disclosure includes: the seat (38) installed on the floor (40) of the passenger cabin (28); and the storage portion (46) provided below the seat and configured to store baggage of the passenger seated on the seat, and at least a part of the storage portion is located below the floor surface (40S) of the passenger cabin. Thus, the passenger can put the baggage in the storage portion while being near the seat.

### Appendix 2

In the moving object described in Appendix 1, the seat may include: the seat portion (381) on which the passenger sits; and the shock absorber (42) configured to absorb the load applied to the seat portion by enabling the seat portion to make reciprocating motion along the vertical direction (Y). This can reduce the impact on the passenger.

### Appendix 3

In the moving object according to Appendix 1 or 2, the seat may include the pair of leg portions (382), and the storage portion may be located between the pair of leg portions in a plan view. Thus, the storage portion is positioned below the seat portion.

### Appendix 4

In the moving object according to any one of Appendixes 1 to 3, the front end (46f) of the storage portion may be located rearward of the front end (38f) of the seat portion (381) provided for the seat, in a plan view. This allows the passenger to place his/her feet on the floor surface located forward of the front end of the seat portion.

### Appendix 5

The moving object according to any one of Appendixes 1 to 4 may further include the displacement restriction portion (50) configured to restrict displacement of the baggage in the vertical direction (Y) inside the storage portion. Thus, the baggage is prevented from coming out of the storage portion.

### Appendix 6

In the moving object according to Appendix 5, the displacement restriction portion may be formed of at least a part of the beam member (401) provided for the floor. Thus, the baggage is prevented from coming out of the storage portion. Moreover, the beam member supporting the floor member is used also as the displacement restriction portion, and thus the number of components provided in the moving object can be suppressed.

### Appendix 7

In the moving object according to Appendix 5, the displacement restriction portion may be a lid member (501) provided for the storage portion. Thus, the baggage is prevented from coming out of the storage portion.

### Appendix 8

In the moving object according to Appendix 7, the storage portion may further include the locking mechanism (64) that maintains the lid member in a closed state. Thus, the baggage is more reliably prevented from coming out of the storage portion.

### Appendix 9

The moving object according to any one of Appendixes 1 to 8, may further include: the sensor (52) configured to detect whether or not the baggage is stored in the storage portion; and the notification unit (54) configured to, when the moving object arrives at the destination and the storage portion stores the baggage, give notification indicating that the baggage is stored in the storage portion. This can prevent the passenger from forgetting to take the baggage out from the storage portion when getting off the moving object.

### Appendix 10

In the moving object according to any one of Appendixes 1 to 9, the space (482) in which components of the moving object is placed may be formed below the storage portion.

### Appendix 11

In the moving object according to any one of Appendixes 1 to 10, the moving object may be a vertical take-off and landing aircraft.

Moreover, it should be noted that the present invention is not limited to the disclosure described above, but various configurations may be adopted therein without departing from the essence and gist of the present invention.

1. A moving object comprising:
a seat installed on a floor of a passenger cabin; and
a storage portion provided below the seat and configured to store baggage of a passenger seated on the seat,
wherein at least a part of the storage portion is located below a floor surface of the passenger cabin.

2. The moving object according to claim 1, wherein the seat includes:
a seat portion on which the passenger sits; and
a shock absorber configured to absorb a load applied to the seat portion by enabling the seat portion to make reciprocating motion along a vertical direction.

3. The moving object according to claim 1, wherein
the seat comprises a pair of leg portions, and
the storage portion is located between the pair of leg portions in a plan view.

4. The moving object according to claim 1, wherein
a front end of the storage portion is located rearward of a front end of a seat portion provided for the seat, in a plan view.

5. The moving object according to claim 1, further comprising:
a displacement restriction member configured to restrict displacement of the baggage in a vertical direction inside the storage portion.

6. The moving object according to claim 5, wherein
the displacement restriction member is formed of at least a part of a beam member provided for the floor.

7. The moving object according to claim 5, wherein
the displacement restriction member is a lid member provided for the storage portion.

8. The moving object according to claim 7, wherein
the storage portion further includes a locking mechanism configured to maintain the lid member in a closed state.

9. The moving object according to claim 1, further comprising:
a sensor configured to detect whether or not the baggage is stored in the storage portion; and
a notification device configured to, when the moving object arrives at a destination and the baggage is stored in the storage portion, give notification indicating that the baggage is stored in the storage portion.

10. The moving object according to claim 1, wherein
a space in which a component of the moving object is placed is formed below the storage portion.

11. The moving object according to claim 1, wherein
the moving object is a vertical take-off and landing aircraft.
